(19) United States
(12) Patent Application Publication
(10) Pub. No.: US 2012/0237312 A1
(43) Pub. Date: Sep. 20, 2012

(54) TORQUE-LIMITING NUT ASSEMBLY

(76) Inventors: Thomas John Widule, New Berlin, WI (US); Nicholas J. Pawluk, Twin Lakes, WI (US); David Bruce Fork, Mukwonago, WI (US); Carl Robert Schultz, West Allis, WI (US)

(21) Appl. No.: 13/047,076

(22) Filed: Mar. 14, 2011

(51) Int. Cl. F16B 33/00

(52) U.S. Cl. 411/7; 411/6

(57) ABSTRACT

A torque-limiting nut assembly, in a preferred form, includes an inner nut engaged with a shaft. A resilient torque member and a rigid torque member are positioned between the inner nut and an outer nut, with each being rotatably fixed to one of the nuts. Rotating the outer nut relative to the inner nut compresses the resilient torque member with the rigid torque member, moving the nuts along the shaft in a first axial direction until the resilient torque member is compressed out of engagement with the rigid torque member. Rotating the outer nut in the opposite direction engages the resilient and rigid torque members thereby urging the nuts in the opposite direction. The torque-limiting nut assembly provides a convenient device to apply the correct amount of application-specific torque.

### CROSS REFERENCES TO RELATED APPLICATIONS

Not applicable.

### STATEMENT REGARDING FEDERALLY SPONSORED RESEARCH

Not applicable.

### BACKGROUND

The present disclosure relates generally to a torque-limiting device. More particularly, the disclosure describes a torque-limiting nut assembly capable of limiting the torque transferred between an outer nut and an inner nut, and thus the ultimate axial force exerted by the torque-limiting nut assembly.

Many applications require that a component be torqued to an application-specific amount. For example, lug nuts used to secure wheels to a hub of a vehicle typically require a certain amount of torque be applied. Under torquing can result in loosening of the lug nuts while over torquing can lead to warping of the brake rotors sandwiched between the wheel and the hub. Similarly, the amount of torque applied to a bearing retaining nut may impact the operation and life of the bearing that is being retained, as well as the bearing retaining nut itself. Similar to the lug nut application, the torque applied to the bearing retaining nut generally relates to an axial force that is applied to a tapered sleeve (as opposed to the wheel/hub) used to secure the member being supported (e.g., a rotating drive shaft). Too much torque or too little torque can result in uneven or accelerated wear of the bearing.

Applying the appropriate amount of torque is often complicated by poor visibility, limited physical access, and generally difficult working conditions. As a result, more traditional torque limiting techniques and tools, such as a torque wrench and torque sticks, are not always suitable (or available) to provide the appropriate application-specific amount of torque. Furthermore, the varied nut sizes are susceptible to erroneous torquing as installers tend to inadvertently over torque relatively smaller nuts and under torque relatively larger nuts.

In light of at least the above considerations, a need exists for an improved torque-limiting nut assembly that is suitable for use in a variety of applications.

### SUMMARY

In one aspect, a torque-limiting nut assembly is capable of engaging external threads of a bearing sleeve and imparting axial movement to an adaptor sleeve that may be captured in the torque-limiting nut assembly. The torque-limiting nut assembly comprises a first nut having a first face and internal threads that are capable of threadably engaging the external threads of the bearing sleeve, and a second nut having a second face facing the first face. A resilient torque member is between the first face and the second face, and is rotatably fixed to one of the nuts. A rigid torque member is between the first face and the second face, and is rotatably fixed to the other nut. Rotation of the second nut in a first direction relative to the bearing sleeve compresses the resilient torque member with the rigid torque member and is capable of moving the adaptor sleeve in a first axial direction until the resilient torque member is compressed out of engagement with the rigid torque member. And, rotation of the second nut in a second direction opposite to the first direction engages the resilient torque member with the rigid torque member to rotate the first nut in the second direction and is capable of moving the adaptor sleeve in a second axial direction opposite to the first axial direction.

In another aspect, a torque-limiting nut assembly engages external threads of a shaft and imparts an axial force to a member engaged with the torque-limiting nut assembly. The torque-limiting nut assembly comprises a first nut having a first face and internal threads threadably engaging the external threads of the shaft, and a second nut having a second face facing the first face. A resilient torque member is between the first face and the second face, and is rotatably fixed to one of the nuts. A rigid torque member is between the first face and the second face, and is rotatably fixed to the other nut. Rotation of the second nut in a first direction relative to the shaft compresses the resilient torque member with the rigid torque member and moves the first nut along the shaft in a first axial direction until the resilient torque member is compressed out of engagement with the rigid torque member. And, rotation of the second nut in a second direction opposite to the first direction engages the resilient torque member with the rigid torque member to rotate the first nut in the second direction and moves the first nut along the shaft in a second axial direction opposite to the first axial direction.

These and still other aspects of the invention will be apparent from the description that follows. In the detailed description, preferred example embodiments will be described with reference to the accompanying drawings. These embodiments do not represent the full scope of the invention; rather, the invention may be employed in many other embodiments. Reference should therefore be made to the claims for determining the full breadth of the invention.

### BRIEF DESCRIPTION OF THE DRAWINGS

FIG. 1 is an isometric view of an example torque-limiting nut assembly.

FIG. 2 is a partial isometric exploded view of the torque-limiting nut assembly shown in FIG. 1.

FIG. 3 is a radial cross-section along line 3-3 through the torque-limiting nut assembly shown in FIG. 1.

FIG. 4 is a detail view of the portion of the cross-section circumscribed by arc 4-4 in FIG. 3.

FIG. 5 is a partial, axial cross-section along line 5-5 of the torque-limiting nut assembly shown in FIG. 1 with the addition of example bearing and adaptor sleeves.

FIG. 6 is an isometric view of another example torque-limiting nut assembly.

FIG. 7 is a partial isometric exploded view of the torque-limiting nut assembly shown in FIG. 6.

FIG. 8 is a cross-section along line 8-8 of the toque-limiting nut assembly shown in FIG. 6.

FIG. 9 is a partial, axial cross-section along line 9-9 of the torque-limiting nut assembly shown in FIG. 6 with the addition of example bearing and adaptor sleeves.

FIG. 10 is a simplified alternative torque member configuration.

FIG. 11 is another simplified alternative torque member configuration.

FIG. 12 is a simplified cross-section of a further example torque-limiting nut assembly.

### DETAILED DESCRIPTION OF THE PREFERRED EXAMPLE EMBODIMENT

Two example torque-limiting bearing nut assemblies and an example torque-limiting lug nut assembly are described; however, one skilled in the art will appreciate the various modifications that can be made to the example embodiments for use in a variety of applications, and yet remain within the scope of the claims. For instance, a component described in the example embodiments as being a discrete, separate component may alternatively be integrally formed with another component of the torque-limiting nut assembly. Additionally, implementation of the general torque-limiting nut assembly concept is subject to various application-specific requirements that will be addressed by one skilled in the art, such as the size, form factor, and materials of the torque-limiting nut assembly, and the approximate torque capable of being transferred via the torque-limiting nut assembly.

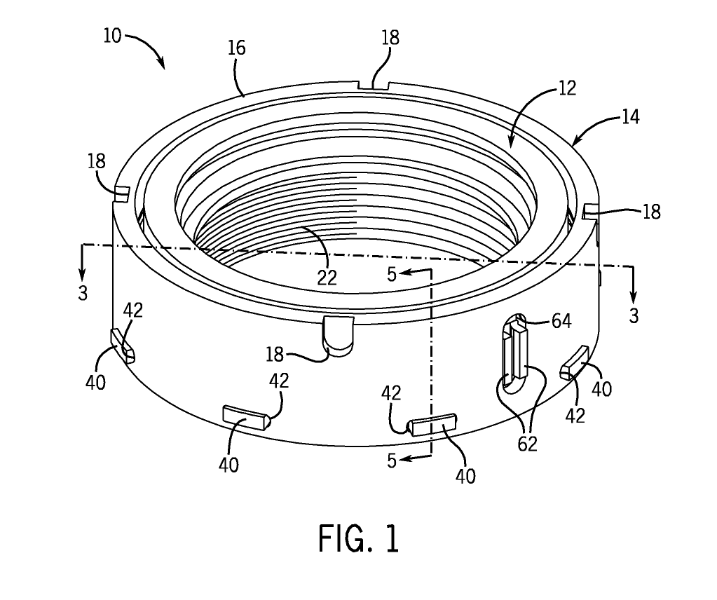

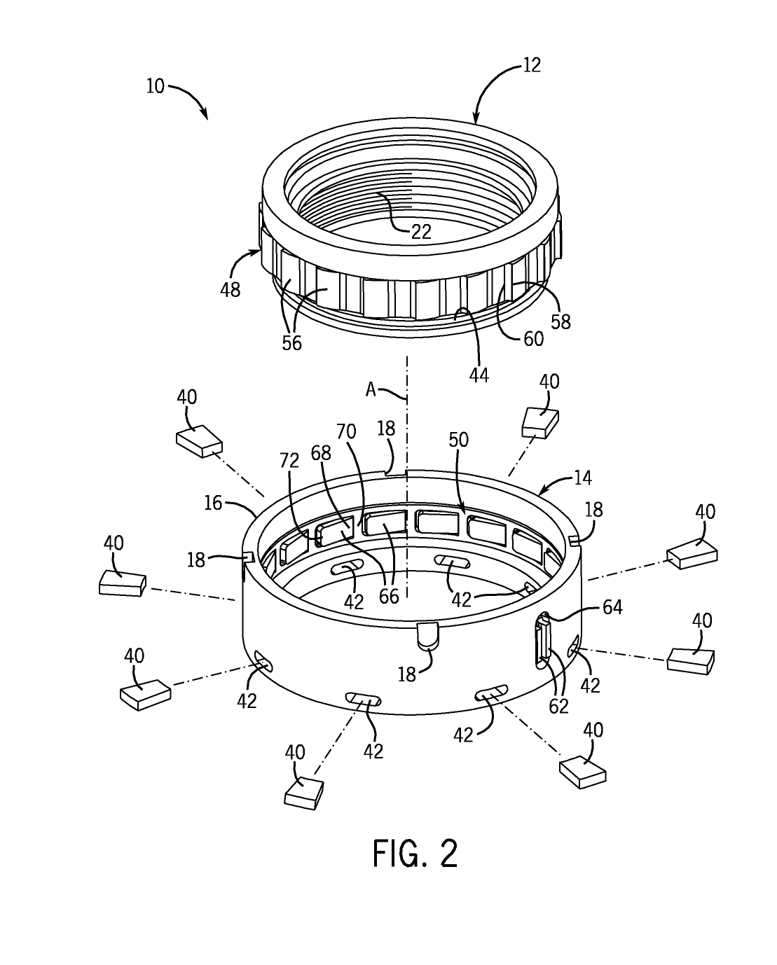

A first example embodiment of a torque-limiting nut assembly is shown generally in FIGS. 1-5 as a torque limiting bearing nut assembly (10). The torque-limiting bearing nut assembly (10) includes an inner nut (12) and an outer nut (14). The outer nut (14) can be rotated relative to the inner nut (12) about the co-axial axis (A) shown in FIG. 2. Rotation of the outer nut (14) in a first direction (e.g., clockwise) results in an approximate, predetermined amount of torque being applied to rotate and tighten the inner nut (12). Once this amount of torque is exceeded, the outer nut (14) “slips” relative to the inner nut (12) such that further rotation of the outer nut (14) will not continue to rotate the inner nut (12), hence limiting the torque applied to the inner nut (12) via the outer nut (14). Rotation of the outer nut (14) in a second direction opposite to the first direction (e.g., counterclockwise) results in the outer nut (14) and the inner nut (12) being coupled such that they rotate in substantial unison. As a result, a requisite application-specific amount of torque can be applied to the inner nut (12) during assembly while sufficient torque can be applied to disassemble the torque-limiting bearing nut assembly (10).

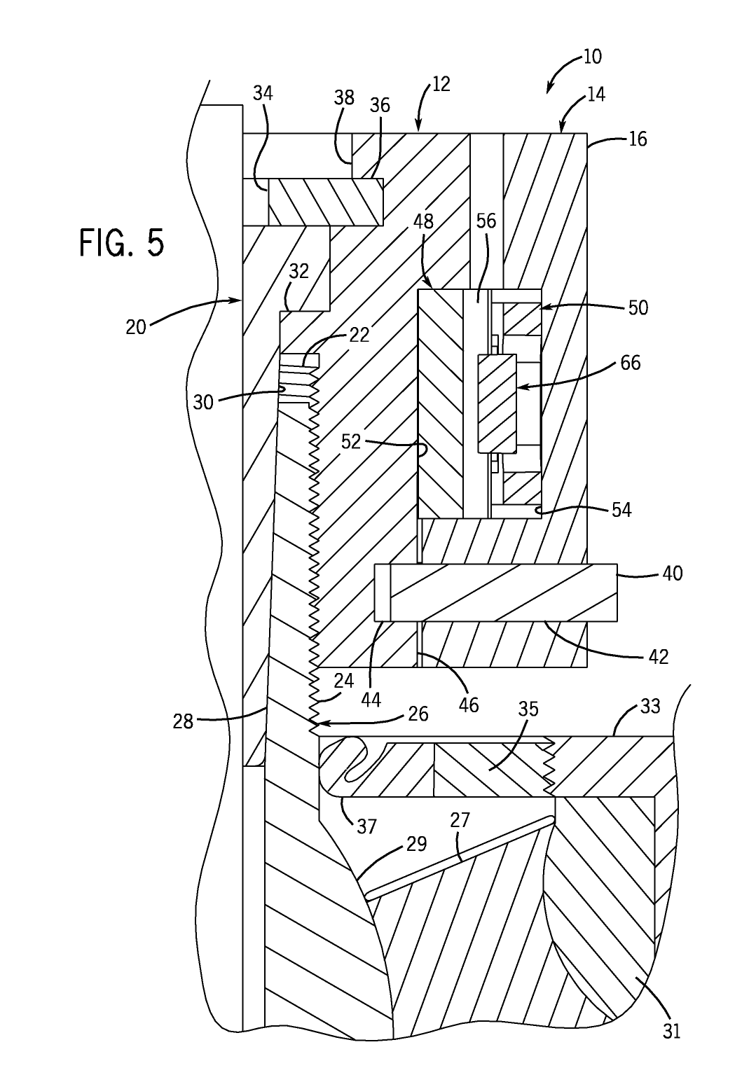

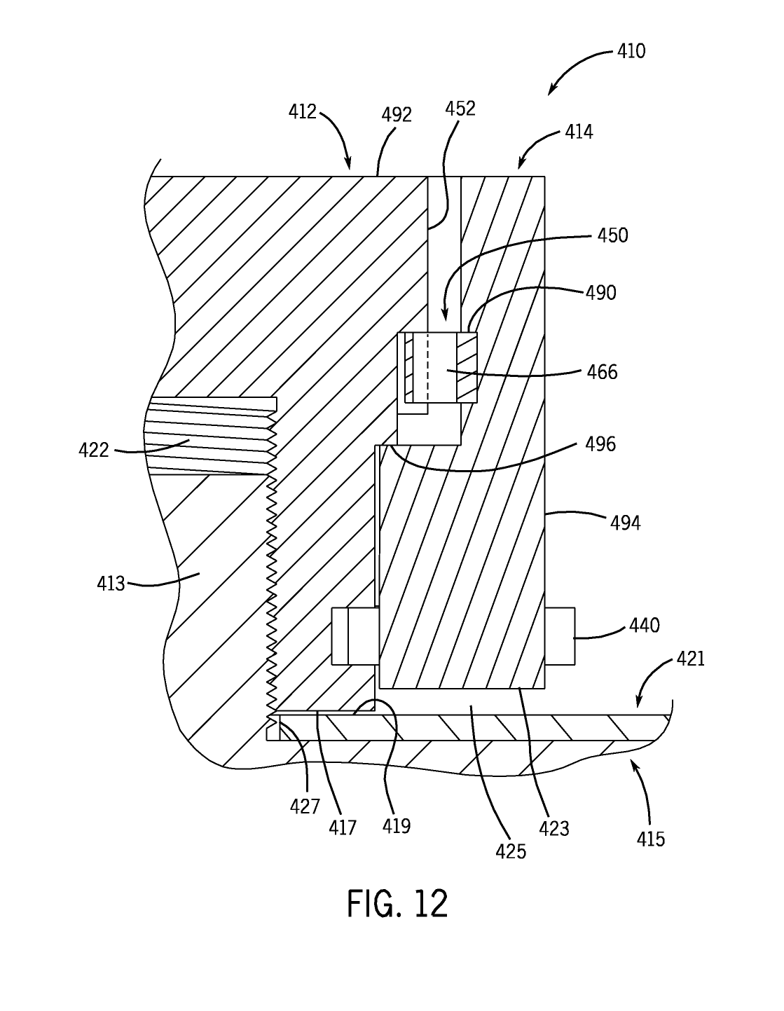

The torque applied to the outer nut (14) and transferred to the inner nut (12) ultimately relates to the amount of axial force applied generally along the axis (A) by the torque-limiting bearing nut assembly (10) to a member shown in the form of an adaptor sleeve (20), shown only in FIG. 5. The inner nut (12) includes internal threads (22) that are configured to engage external threads (24) formed on a shaft shown in the form of a bearing sleeve (26). The bearing sleeve (26) is fixed relative to the torque-limiting bearing nut assembly (10) such that during assembly and disassembly the inner nut (12) and outer nut (14) can rotate relative to the bearing sleeve (26). As will be appreciated by one skilled in the art in view of this disclosure, the “member” and “shaft” may comprise various elements and structures depending upon the specific application of the torque-limiting nut assembly, one alternative arrangement of which is described with reference to FIG. 12.

In the example embodiment, the bearing sleeve (26) defines an internal annular surface (28) that flairs toward the lower portion (as oriented in FIG. 5) of the torque-limiting bearing nut assembly (10). The adaptor sleeve (20) defines an external annular surface (30) that tapers toward the lower portion of the torque-limiting bearing nut assembly (10) and engages to wedge with the internal annular surface (28) of the bearing sleeve (26) during installation of the torque-limiting bearing nut assembly (10).

In the example bearing arrangement shown in FIG. 5, a roller (27) is positioned within a raceway between an inner race (29) defined by the bearing sleeve (26) and an outer race (31) secured in an outer housing (33). The outer housing (33) includes a mounting ring (35) configured to retain a seal ring (37) that inhibits contaminants from fouling the rollers (27). The configuration shown is similar to that found in U.S. Pat. No. 7,503,698, which is hereby incorporated by reference as if fully set forth herein. One skilled in the art will appreciate the various bearing arrangements suitable for use with the torque-limiting nut assembly.

The inner nut (12), outer nut (14), and adaptor sleeve (20) may be formed from cold drawn steel (e.g., 60,000 psig), or any other suitable material given the specific application requirements. The bearing sleeve (26) may be made of heat treated steel, or again, any other suitable material as the particular application requirements allow.

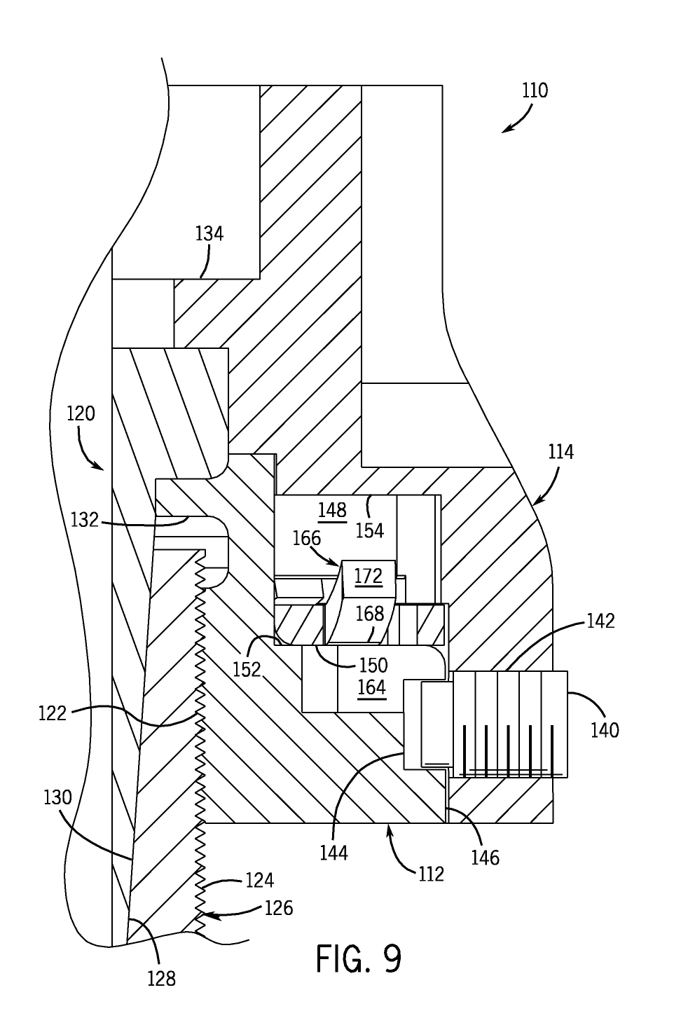

In the example embodiment illustrated in FIGS. 1-5, and with specific reference to FIG. 5, the adaptor sleeve (20) is axially captured between a first engagement member in the form of an annular lip (32) that extends radially inward from the inner nut (12) and a second engagement member in the form of a snap ring (34) seated in an annular recess (36) formed in an interior face (38) of the inner nut (12). While this configuration provides easy assembly of the adaptor sleeve (20) into the inner nut (12), one skilled in the art will appreciate the variety of other configurations available, one of which is illustrated in FIG. 9 and will be discussed below.

Returning to FIGS. 1 and 2, the outer nut (14) is axially captured to the inner nut (12) by multiple members in the form of wedges (40) that extend through multiple openings (42) formed through the outer nut (14) to engage an annular groove (44) formed in an exterior surface (46) of the inner nut (12). Thus, when the inner nut (12) is nested within the outer nut (14), the wedges (40) riding in the annular groove (44) allow relative rotation of the inner nut (12) and the outer nut (14), but inhibit axial movement along the axis (A). The wedges (40) may be made of ultra high molecular weight polyethylene or any other suitable material.

In the example shown, an upper rim (16) of the outer nut (14) includes a series of slots (18) formed about the circumference of the upper rim (16) for engagement with a spanner wrench, thereby allowing the outer nut (14) to be rotated (i.e., torqued). Alternatively, as one skilled in the art will appreciate, a variety of other configurations are available to apply torque to the outer nut (14), for instance, the upper rim (16) may be square, octagonal, hexagonal, and the like such that an open end wrench or other tool may be used. In some instances, the upper rim (16) may define a handle such that an installer need not use any tools to torque the outer nut (14).

The applied torque is transferred between the outer nut (14) and inner nut (12) via interaction between a rigid torque member (illustrated as a tooth ring (48)) and a resilient torque member (illustrated as a spring ring (50)). In general, the amount of torque transferred between the outer nut (14) and the inner nut (12) is limited by the engagement between the rigid torque member and the resilient torque member, that is, once the resilient torque member has been compressed or deformed out of engagement with the rigid torque member, the approximate maximum torque has been applied upon the inner nut (12).

In the first example embodiment, the tooth ring (48) is rotatably fixed relative to a substantially radially facing face (52) of the inner nut (12) and the spring ring (50) is rotatably fixed relative to a substantially radially facing face (54) of the outer nut (14). As best shown in FIG. 5, when the inner nut (12) and outer nut (14) are assembled, the face (52) of the inner nut (12) faces the face (54) of the outer nut (14). Of course, the relative arrangement of the rigid torque member and resilient torque member may be inversed, that is, the spring ring (50) may be fixed to the inner nut (12) and the tooth ring (48) may be fixed to the outer nut (14).

In the example embodiment, the tooth ring (48) is in the form of a continuous band rotatably fixed to the face (52) of the inner nut (12) and is made of heat treated steel, but may be made of other suitable materials (e.g., plastics) as the particular application requirements allow. The tooth ring (48) may, for instance, be a separate plastic component secured (e.g., glued) to the inner nut (12) or formed integrally with the inner nut (12). As best shown in FIGS. 2-4, the tooth ring (48) includes multiple teeth (56) evenly spaced about the circumference of the tooth ring (48). With specific reference to FIG. 4, each tooth (56) defines a peak (58) and a valley (60), both of which are configured to selectively engage the spring ring (50) as the outer nut (14) rotates.

In the example shown in FIGS. 1-5, the spring ring (50) is in the form of a cylindrical strip having a pair of tabs (62) oriented radially outward at both ends of the spring ring (50). The spring ring (50) is rotatably fixed relative to the outer nut (14) by seating the tabs (62) into an axial slot (64) formed through the outer nut (14), as best shown in FIGS. 1-3. Alternatively, the spring ring (50) may be integrally formed with the outer nut (14). In other forms, the spring ring (50) may be metallic and welded to form a continuous ring and to secure it to the inner nut (12) or outer nut (14).

The spring ring (50) includes multiple resilient fingers (66) that extend generally circumferentially and radially inward toward the tooth ring (48). As best shown in FIGS. 2 and 4, each resilient finger (66) extends from its base (68) near a rung (70) of the ladder-shaped cylindrical strip and ends in a tip (72). In one preferred form, each resilient finger (66) defines an angle (8) of approximately eighteen degrees relative to a tangential line passing through the base (68) of each resilient finger (66) (as best shown in FIG. 4). The resilient fingers (66) are formed or configured such that in a relaxed (i.e., uncompressed) state, the resilient fingers (66) engage the multiple mating teeth (56) of the tooth ring (48). The spring ring (50) may be made of heat treated spring steel or various other materials (e.g., polymers and composites) as the particular application torque requirements may allow.

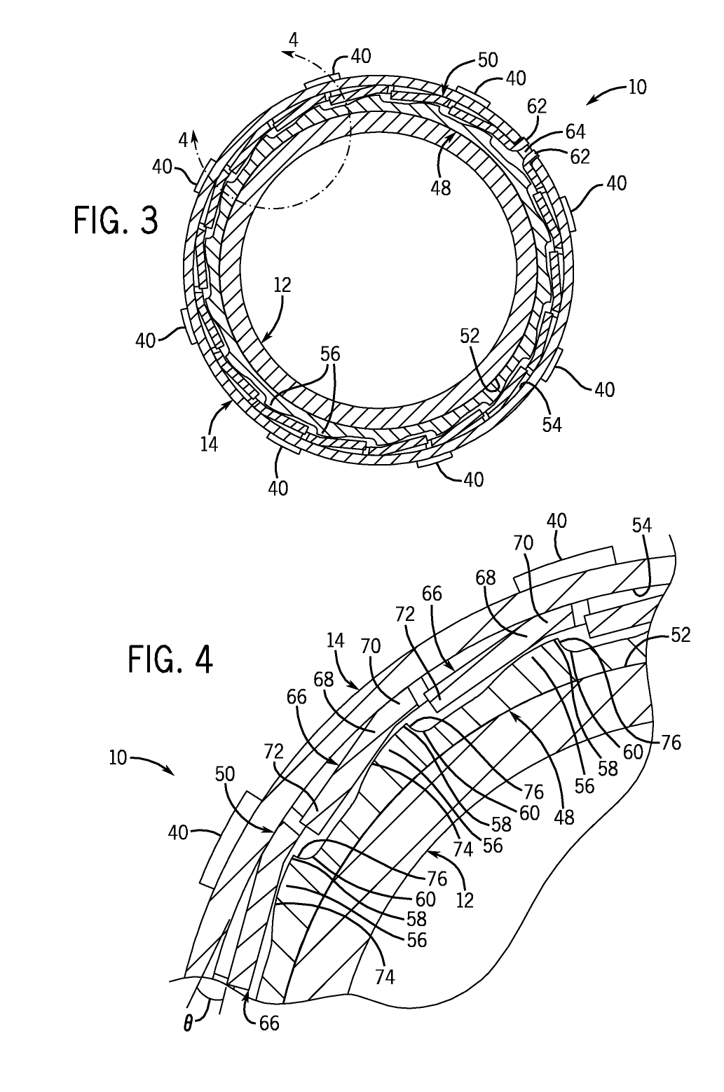

In operation, the configuration of the engagement between the rigid torque member and the resilient torque member provides the torque-limiting features as well as allows disassembly of the example torque-limiting bearing nut assembly (10). With specific reference to FIGS. 3-5, rotating the outer nut (14) (and spring ring (50) rotatably coupled thereto) in a clockwise direction (as viewed in FIG. 3) will cause the resilient fingers (66) of the spring ring (50) to engage against the teeth (56). Provided the compressive forces resulting from the applied torque are insufficient to compress the resilient fingers (66) out of engagement with the teeth (56), a portion of the rotational force applied to rotate the outer nut (14) will be transferred via the engagement between the spring ring (50) and tooth ring (48) causing the inner nut (12) to also rotate in a clockwise direction. Given that the inner nut (12) is threadably engaged with the bearing sleeve (26), the inner nut (12) also translates axially along the axis (A) thereby axially urging the snap ring (34) into engagement with the adaptor sleeve (20). As a result, the adaptor sleeve (20) is seated between the supported member (e.g., shaft) and the bearing sleeve (26).

As the adaptor sleeve (20) is further wedged, additional torque is generally applied to the outer nut (14). This additional torque causes further compression (e.g., radial deformation) of the resilient fingers (66) contrary to the natural position and orientation of the resilient fingers (66). At some level of applied torque, the exact level of which is application specific and may vary depending upon application conditions, the resilient fingers (66) will be compressed out of engagement with the teeth (56) such that the tip (72) of each resilient finger (66) will have slid along a ramp (74) (shown in FIG. 4) past the peak (58) and into the adjacent valley (60). Thus, the outer nut (14) begins to “slip” relative to the inner nut (12) indicating that the inner nut (12) has been torqued or tightened to the desired amount. Similarly, the axial force applied to seat the adaptor sleeve (20) is also limited, thereby inhibiting over-tightening.

Rotating the outer nut (14) in a counterclockwise direction (again with reference to FIG. 3) results in the resilient torque member and the rigid torque member engaging such that sufficient torque may be applied to the outer nut (14) to loosen the inner nut (12) and unseat the adaptor sleeve (20). In the example torque-limiting bearing nut assembly (10) shown in FIGS. 1-5, the tips (72) of the resilient fingers (66), when in the generally uncompressed state, engage the valley (60) side of the teeth (56). As shown best in FIG. 4, the valley (60) defines a steep ramp (76) that the tip (72) of the resilient finger (66) engages when the outer nut (14) is rotated in the counterclockwise direction. As a result, a reduced portion of the rotational force is applied radially outward to compress the resilient fingers (66), allowing the application of additional torque to rotate the inner nut (12) and thus unseat the adaptor sleeve (20). Specifically, as the inner nut (12) rotates counterclockwise, the threaded engagement with the bearing sleeve (26) translates the inner nut (12) along the axis (A) such that the annular lip (32) of the inner nut (12) engages and unseats the adaptor sleeve (20).

In the example shown, the teeth (56) and the resilient fingers (66) are evenly spaced about the circumference of the inner nut (12) and outer nut (14), respectively. As a result, each engagement between a mating tooth (56) and resilient finger (66) occurs approximately simultaneously as the outer nut (14) is rotated; this configuration provides a first type of torque transfer scenario as the outer nut (14) is rotated. In alternative configurations, the circumferential spacing of the teeth (56) and/or resilient fingers (66) may be unequal such that fewer or greater pairs of teeth (56) and resilient fingers (66) come into engagement as the outer nut (14) is rotated, thus providing a different torque transfer scenario (e.g., exponential versus linear).

In any of the configurations, the number of teeth (56) and/or resilient fingers (66), length of each tooth (56) and/or resilient finger (66), angle (8) of each resilient finger (66), material properties (e.g., spring constant) of the resilient fingers (66), and the like may be altered to obtain the desired operational characteristics of the torque-limiting bearing nut assembly (10). For instance, the length of adjacent resilient fingers (66) may increase circumferentially from a minimum length in a counterclockwise direction such that increased engagement between teeth (56) and resilient fingers (66) is achieved as the outer nut (14) is rotated clockwise. One skilled in the art will appreciate the various alterations available in view of this disclosure.

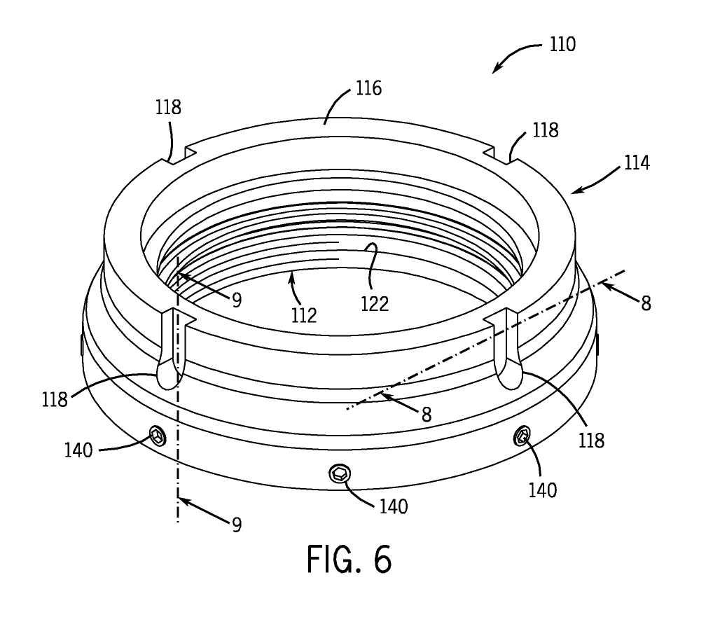

A second example embodiment of a torque-limiting nut assembly is shown in FIGS. 6-9 as a torque-limiting bearing nut assembly (110). The torque-limiting bearing nut assembly (110) includes an inner nut (112) and an outer nut (114). Again, the outer nut (114) can be rotated relative to the inner nut (112) about a co-axial axis. As with the first example torque-limiting bearing nut assembly (10), rotation of the outer nut (114) in a first direction (e.g., clockwise) results in a predetermined amount of torque being applied to rotate and tighten the inner nut (112). Once this amount of torque is exceeded, the outer nut (114) “slips” relative to the inner nut (112) such that further rotation of the outer nut (114) will not continue to rotate and tighten the inner nut (112), hence limiting the torque applied to the inner nut (112) via the outer nut (114). Rotation of the outer nut (114) in a second direction opposite to the first direction (e.g., counterclockwise) results in the outer nut (114) and the inner nut (112) being coupled such that they generally rotate in substantial unison. As a result, a requisite application-specific amount of torque can be applied to the inner nut (112) during assembly while sufficient torque can be applied to disassemble the torque-limiting bearing nut assembly (110).

The torque applied to the outer nut (114) and transferred to the inner nut (112) again determines the amount of axial force applied to an adaptor sleeve (120), shown only in FIG. 9. The inner nut (112) includes internal threads (122) that are configured to engage external threads (124) formed on a bearing sleeve (126). In the second example embodiment, the bearing sleeve (126) is fixed relative to the torque-limiting bearing nut assembly (110) such that during assembly and disassembly the inner nut (112) and outer nut (114) can rotate relative to the bearing sleeve (126). Again, the bearing sleeve (126) defines an internal annular surface (128) that flairs toward the lower portion of the torque-limiting bearing nut assembly (110), and the adaptor sleeve (120) defines an external annular surface (130) that tapers toward the lower portion of the torque-limiting bearing nut assembly (110). As a result, the internal annular surface (128) and the external annular surface (130) engage and wedge during installation of the torque-limiting bearing nut assembly (110) to a supported member (e.g., a shaft). The example bearing arrangement is not shown in FIG. 9, but is similar to that bearing arrangement described with reference to FIG. 5.

With specific reference to FIG. 9, the adaptor sleeve (120) is axially captured between a first protrusion in the form of a first annular lip (132) that extends radially inward from the inner nut (112) and a second protrusion in the form of a second annular lip (134) that extends radially inward from the outer nut (114). While the first protrusion and second protrusion are described as annular, the protrusions may take a variety of other form factors, such as one or more nib, key, tab, and the like that captures the adaptor sleeve (120); alternatively, the adaptor sleeve (120) may be integral with the outer nut (114), for instance.

With specific reference to FIGS. 6, 7, and 9, the outer nut (114) is axially captured to the inner nut (112) by multiple members in the form of dog point style set screws (140). The set screws (140) are threaded into multiple openings (142) formed in the outer nut (114) to engage an annular groove (144) formed in an exterior surface (146) of the inner nut (112). Thus, when the inner nut (112) is nested within the outer nut (114), the set screws (140) riding in the annular groove (144) allow relative rotation of the inner nut (112) and outer nut (114), but inhibit axial movement. As with the first example torque-limiting bearing nut assembly (10), an upper rim (116) of the outer nut (114) includes a series of slots (118) formed about the circumference of the upper rim (116) for engagement with a spanner wrench, thereby allowing the outer nut (114) to be rotated (i.e., torqued).

The torque applied to the second example torque-limiting bearing nut assembly (110) is transferred between the outer nut (114) and inner nut (112) via interaction between a rigid torque member (illustrated as teeth (148)) and a resilient torque member (illustrated as a spring ring (150)). The amount of torque transferred between the outer nut (114) and the inner nut (112) is limited by the engagement between the rigid torque member and the resilient torque member, that is, once the resilient torque member has been compressed out of engagement with the rigid torque member, the approximate maximum torque has been applied upon the inner nut (112).

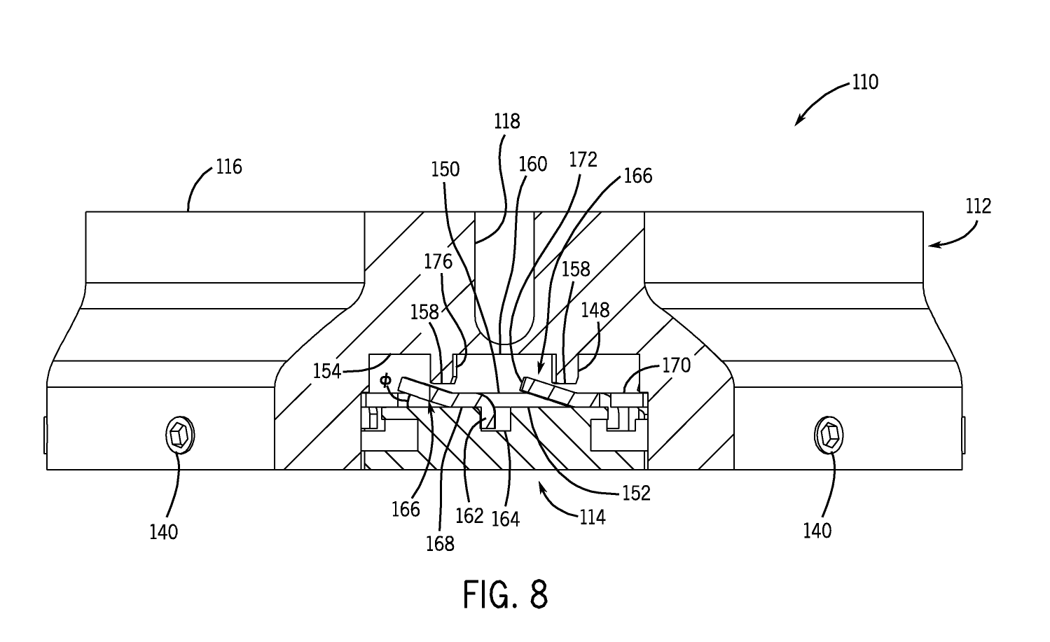

In the second example embodiment, the teeth (148) are integrally formed in a substantially axially facing face (154) of the outer nut (114) and the spring ring (150) is rotatably fixed relative to a substantially axially facing face (152) of the inner nut (112). As best shown in FIGS. 8 and 9, when the inner nut (112) and outer nut (114) are assembled, the face (152) of the inner nut (112) faces the face (154) of the outer nut (114). Again, the relative arrangement of the rigid torque member and resilient torque member may be inversed, that is, the spring ring (150) may be fixed to the outer nut (114) and the teeth (148) may be integrally formed with the inner nut (112). Moreover, while the faces (52, 54, 152, 154) have been described as substantially radial or substantially axial, the orientation of the faces (52, 54, 152, 154) may be configured at any intermediate position, and need not be exactly radial or axial.

In the example embodiment, the teeth (148) are evenly spaced about the circumference of the tooth face (154) of the outer nut (114). As best illustrated in FIG. 8, each tooth (148) defines a peak (158) and a valley (160) between adjacent teeth (148), both of which are configured to selectively engage the spring ring (150) as the outer nut (114) rotates.

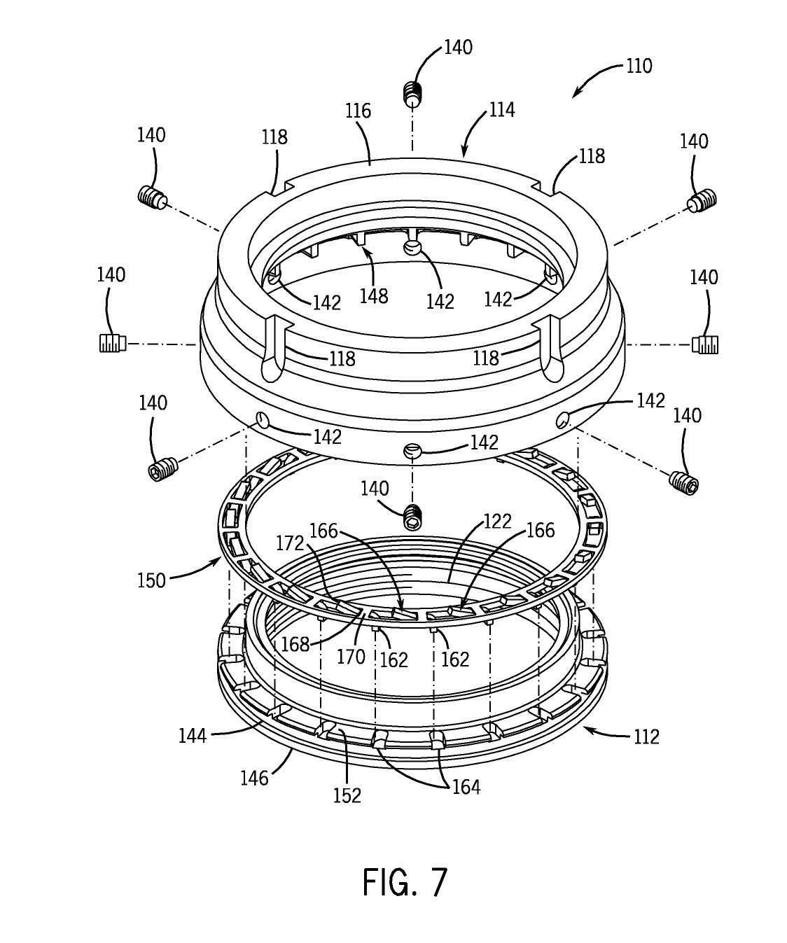

The spring ring (150), best shown in FIGS. 7-9, is in the form of a disc-shaped strip having multiple hold tabs (162) oriented substantially perpendicular to a plane of the spring ring (150). The spring ring (150) is rotatably fixed relative to the inner nut (112) by seating hold tabs (162) into respective notches (164) formed in the face (152) of the inner nut (112), as best shown in FIGS. 7 and 8. Alternatively, the spring ring (150) may be integrally formed with the inner nut (112), for example.

The spring ring (150) includes multiple resilient fingers (166) that extend generally circumferentially and axially toward the teeth (148). Each resilient finger (166) extends from its base (168) near a rung (170) of the ladder-shaped disc and ends in a tip (172). In one preferred form, each resilient finger (166) defines an angle (q) of approximately eighteen degrees relative to the plane of the spring ring (150) proximate the face (152) of the inner nut (112) (as best shown in FIG. 8). The resilient fingers (166) are formed or configured such that in a relaxed (i.e., uncompressed) state, the resilient fingers (166) engage the multiple mating teeth (148).

In operation, as with the first embodiment described, the configuration of the engagement between the rigid torque member and the resilient torque member provides the torque-limiting features as well as allows disassembly of the example torque-limiting bearing nut assembly (110). With specific reference to FIGS. 7-9, rotating the outer nut (114) (and teeth (148) integral therewith) in a clockwise direction will cause the resilient fingers (166) of the spring ring (150) to engage against the teeth (148). Provided the compressive forces resulting from the applied torque are insufficient to compress the resilient fingers (166) out of engagement with the teeth (148), a portion of the rotational force applied to the outer nut (114) will be transferred via the engagement between the resilient fingers (166) and the teeth (148) causing the inner nut (112) to also rotate in a clockwise direction. Given that the inner nut (112) is threadably engaged with the bearing sleeve (126), the inner nut (112) (and axially coupled outer nut (114)) also translates axially thereby axially urging the annular lip (134) of the outer nut (114) into engagement with the adaptor sleeve (120). As a result, the adaptor sleeve (120) is seated between the supported member and the bearing sleeve (126).

As the adaptor sleeve (120) is further wedged, additional torque is generally applied to the outer nut (114). This additional torque causes further compression (e.g., axial deformation) of the resilient fingers (166) contrary to the natural position and orientation of the resilient fingers (166). At some level of applied torque, again the exact level of which is application specific, the resilient fingers (166) will be compressed out of engagement with the teeth (148) such that the tip (172) of each resilient finger (166) will have slid along the tooth (148), past the peak (158), and into the valley (160) between adjacent peaks (158). Thus, the outer nut (114) begins to “slip” relative to the inner nut (112) indicating that the inner nut (112) has been torqued to the desired amount. Similarly, the axial force applied to seat the adaptor sleeve (120) is also limited, thereby inhibiting over-tightening.

Rotating the outer nut (114) in a counterclockwise direction results in the resilient torque member and the rigid torque member engaging such that sufficient torque may be applied to the outer nut (114) to loosen the inner nut (112) and unseat the adaptor sleeve (120). In the example torque-limiting bearing nut assembly (110) shown in FIGS. 2-9, the tips (172) of the resilient fingers (166), when in the generally uncompressed state, engage the valley (160) near the base of the teeth (156). As shown best in FIG. 8, each tooth (148) defines a wall (176) that the tip (172) of the resilient finger (166) engages when the outer nut (114) is rotated in the counterclockwise direction. As a result, a smaller portion of the rotational force is applied axially to compress the resilient fingers (166), allowing the application of additional torque to unseat the adaptor sleeve (120). Specifically, as the inner nut (112) rotates counterclockwise, the threaded engagement with the bearing sleeve (126) translates the inner nut (112) axially such that the annular lip (132) of the inner nut (112) engages and unseats the adaptor sleeve (120).

In the example shown, the resilient fingers (166) and hold tabs (162) are evenly spaced about the circumference of the spring ring (150) and are preferably formed from a continuous metal ring. As with the first example torque-limiting bearing nut assembly (10), the configuration of the resilient fingers (166), hold tabs (162), and teeth (148) may be arranged in a variety of manners to achieve the desired, application-specific torque transfer characteristics.

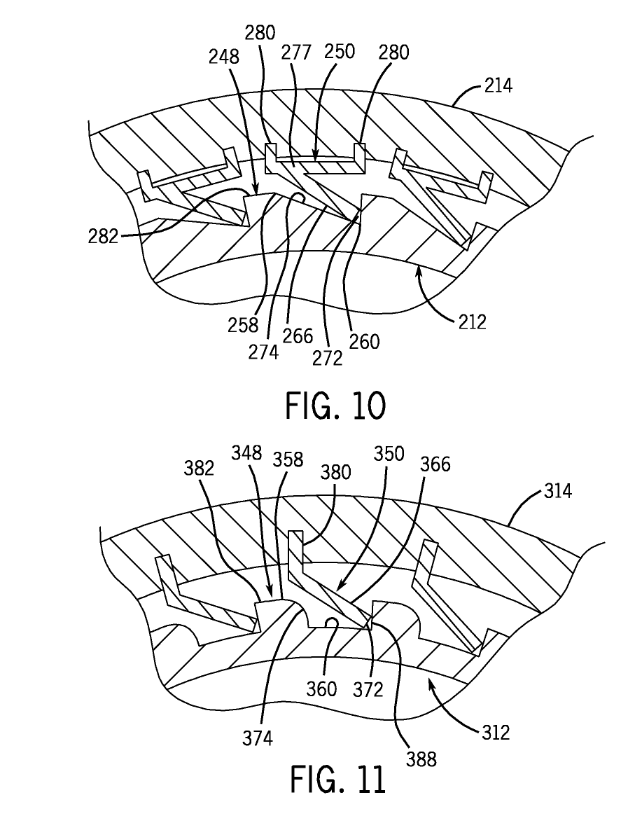

Turning to FIGS. 10 and 11, two additional resilient torque member and rigid torque member configurations are shown in simplified forms. With specific reference to FIG. 10, resilient torque members are shown in the form of discrete spring clips (250) each having a pair of legs (280) that clip into or engage mating openings formed in an outer nut (214); the spring clips (250) are spaced circumferentially about the outer nut (214). A resilient finger (266) extends from a web (277) between the legs (280) towards a series of teeth (248) integrally formed with an inner nut (212). The teeth (248) define a ramp (274) between a valley (260) and a peak (258). A plateau (282) is located between a peak (258) and an adjacent valley (260), opposite the ramp (274). In the configuration shown in FIG. 10, rotating the outer nut (214) in the clockwise direction engages a tip (272) of the resilient fingers (266) into the valley (260), thereby rotationally coupling the outer nut (214) and the inner nut (212) in the clockwise direction. Rotating the outer nut (214) in the counterclockwise direction causes the resilient finger (266) to compress in response to increasing torque as it rides along the ramp (274) until it reaches the plateau (282). Thus, this counterclockwise rotation of the outer nut (214) results in torque being transferred to the inner nut (212) until the resilient finger (266) is compressed out of engagement with the mating tooth (248).

With specific reference to FIG. 11, resilient torque members are shown in the form of discrete angle arms (350) having a base (380) integrally molded with the outer nut (314). Alternatively, the base (380) may be slid into a groove formed in the outer nut (314). A resilient finger (366) extends toward a series of teeth (348) integrally formed with an inner nut (312). The teeth (348) define a ramp (374) between a valley (360) and a peak (358). In the configuration shown in FIG. 11, rotating the outer nut (314) in the clockwise direction engages a tip (372) of the resilient fingers (366) into a corner (388) defined by the valley (360), thereby rotationally coupling the outer nut (314) and the inner nut (312) in the clockwise direction. Rotating the outer nut (314) in the counterclockwise direction causes the resilient finger (366) to compress in response to increasing torque as it rides along the ramp (374) until it reaches a plateau (382). Thus, this counterclockwise rotation of the outer nut (314) results in torque being transferred to the inner nut (312) until the resilient finger (366) is compressed out of engagement with the mating tooth (348).

Turning to FIG. 12, a third example torque-limiting nut assembly is shown in the form of a torque-limiting lug nut assembly (410). An inner nut (412) is nested within an outer nut (414) and the outer nut (414) is axially captured to the inner nut via a series of members (440) (e.g., wedges, pins). The inner nut (412) has a face (452) that includes multiple teeth (456) integrally formed therein (i.e., a form of a rigid torque member). The outer nut (414) includes an annular recess (490) into which a spring ring (450) is secured (i.e., a form of a resilient torque member).

To aid assembly of the inner nut (412) and the outer nut (414), the inner nut (412) includes a stepped head portion (492) and the outer nut (414) includes a mating stepped head portion (494). As shown in FIG. 12, when the inner nut (412) is nested within the outer nut (414) at the desired location, the stepped head portions (492, 494) engage at an interface (496), thereby inhibiting misalignment that may damage the resilient member (e.g., the spring ring (450)). Many other configurations are available to establish the interface (496), such as tabs, nibs, lips, pins, and the like, and will be appreciated by one of ordinary skill in the art when given the benefit of this disclosure.

The inner nut (412) is in the general form of a capped lug nut having internal threads (422). The inner nut (412) is shown threadably engaged with a shaft in the form of a lug (413) that extends from a member in the form of a hub (415) and through an opening (427) in a captured member (421) (e.g., a wheel, as in common axle configurations). During operation, rotating the outer nut (414) about the lug (413) results in the multiple teeth (456) and spring ring (450) engaging to rotate the inner nut (412) about the lug (413). The inner nut (412) defines an end face (417) that abuts and is urged into contact with a mounting surface (419) of the captured member (421) to ultimately sandwich the member (421) between the end face (417) of the inner nut (412) and the hub (415). Note that the outer nut (414) is configured to have an end face (423) that is offset from the end face (417) of the inner nut (412) to provide a gap (425) between the outer nut (414) and the sandwiched member (421), ensuring that the outer nut (414) does not prevent the inner nut (412) from urging the member (421) against the hub (415).

As the inner nut (412) moves axially into engagement with the member (421), and thus hub (415), additional torque is applied to the outer nut (414). When the applied torque reaches the approximate desired maximum for the particular application, the multiple teeth (456) will compress or deflect the spring ring (450) out of engagement such that the multiple teeth (456) “slip” past the spring ring (450) (more specifically resilient fingers (466) of the spring ring (450)). At this point, the inner nut (412) is tightened to the desired level. To loosen the inner nut (412), the outer nut (414) is rotated in the opposite direction (e.g., counterclockwise), which causes the resilient fingers (466) to engage the teeth such that the inner nut (412) and outer nut (414) are engaged and rotate substantially in unison moving axially away from the hub (415).

Any of the resilient torque member and rigid torque member configurations described above may be configured to provide an audible signal that the outer nut (14) is rotating relative to the inner nut (12) (i.e., “slipping”) and thus the torque (and hence axial force on the adaptor sleeve (20)) has reached the desired level. For example, as the resilient fingers (366) in FIG. 11 spring back to their substantially uncompressed position, the tip (372) audibly “clicks” during engagement with the valley (360). Moreover, one skilled in the art will appreciate that a seal (e.g., o-ring) may be fitted between the inner nut (12) and the outer nut (14) to inhibit contaminants from fouling the operation of the torque-limiting bearing nut assembly (10).

While there has been shown and described what is at present considered the preferred embodiments of the invention, it will be obvious to those skilled in the art that various changes and modifications can be made, given the benefit of this disclosure, without departing from the scope of the invention defined by the following claims. For example, the above described embodiments can be used to couple any structure to a shaft without departing from the scope of the invention.

We claim:

1. A torque-limiting nut assembly capable of engaging external threads of a bearing sleeve and imparting axial movement to an adaptor sleeve that may be captured in the torque-limiting nut assembly, comprising:
a first nut having a first face and internal threads capable of threadably engaging the external threads of the bearing sleeve;
a second nut having a second face facing the first face;
a resilient torque member between the first face and the second face, and rotatably fixed to one of the first nut and the second nut; and
a rigid torque member between the first face and the second face, and rotatably fixed to the other of the one of the first nut and second nut;
wherein rotation of the second nut in a first direction relative to the bearing sleeve compresses the resilient torque member with the rigid torque member and is capable of moving the adaptor sleeve in a first axial direction until the resilient torque member is compressed out of engagement with the rigid torque member; and
wherein rotation of the second nut in a second direction opposite to the first direction engages the resilient torque member with the rigid torque member to rotate the first nut in the second direction and is capable of moving the adaptor sleeve in a second axial direction opposite the first axial direction.

2. The torque-limiting nut assembly of claim 1, further comprising:
a first engagement member defined by the first nut; and
a second engagement member defined by at least one of the first nut and the second nut;
wherein rotation of the second nut in the first direction engages the second engagement member and the adaptor sleeve to move the adaptor sleeve in the first axial direction; and
wherein rotation of the second nut in the second direction engages the first engagement member and the adaptor sleeve to move the adaptor sleeve in the second axial direction.

3. The torque-limiting nut assembly of claim 2, wherein:
the first engagement member comprises a first annular lip extending radially inward from the first nut; and
the second engagement member comprises a second annular lip extending radially inward from at least one of the first nut and the second nut.

4. The torque-limiting nut assembly of claim 1, further comprising:
a recess formed in an interior face of the first nut; and
a snap ring seated in the recess;
wherein rotation of the second nut in the first direction engages the snap ring and the adaptor sleeve.

5. The torque-limiting nut assembly of claim 1, wherein:
the rigid torque member is rotatably fixed to the second nut;
the rigid torque member comprises a plurality of teeth extending from the second surface toward the resilient torque member; and
the plurality of teeth are integrally formed in the second nut.

6. The torque-limiting nut assembly of claim 1, wherein the first face and the second face are both at least one of axially facing and radially facing.

7. The torque-limiting nut assembly of claim 1, wherein the resilient torque member comprises at least one resilient finger extending toward the rigid torque member.

8. The torque-limiting nut assembly of claim 7, wherein:
the at least one resilient finger includes multiple resilient fingers, each resilient finger defining a length; and
the length of each of the multiple resilient fingers is different from an adjacent resilient finger.

9. The torque-limiting nut assembly of claim 7, wherein the at least one resilient finger includes multiple resilient fingers evenly spaced about a circumference of the resilient torque member.

10. The torque-limiting nut assembly of claim 1, wherein:
the resilient torque member includes multiple resilient torque members;
the rigid torque member includes multiple rigid torque members; and
spacing between adjacent torque members and spacing between adjacent rigid torque members is configured such that as the second nut is rotated in the first direction engagement between resilient torque members and mating rigid torque members increases.

11. The torque-limiting nut assembly of claim 1, further comprising:
an annular groove formed in an exterior surface of the first nut;
an opening formed through the second nut and aligned with the annular groove when the first nut is at least partially within the second nut; and
a member engaged with the opening and extending into the annular groove to axially capture the second nut to the first nut.

12. The torque-limiting nut assembly of claim 1 wherein the resilient torque member comprises a plurality of discrete members spaced apart along the second face of the second nut.

13. The torque-limiting nut assembly of claim 1, wherein:
the resilient torque member includes multiple resilient fingers, each resilient finger defining an angle relative to at least one of the first face and the second face; and
the angle of each of the multiple resilient fingers is different from an adjacent resilient finger.

14. The torque-limiting nut assembly of claim 1, wherein:
the rigid torque member comprises a tooth formed in one of the first face and the second face;
the resilient torque member comprises a spring ring including a hold tab and a resilient finger, the hold tab extending into a notch formed in the other of the one of the first face and the second face, and the resilient finger extending toward the tooth; and
rotation of the second nut in the first direction compresses the resilient finger with the tooth to rotate the first nut in the first direction until the resilient finger is compressed out of engagement with the tooth, and rotation in the second direction opposite to the first direction engages the resilient finger with the tooth to rotate the first nut in the second direction.

15. The torque-limiting nut assembly of claim 1, wherein:
the rigid torque member comprises a tooth ring rotatably fixed to one of the first face and the second face, the tooth ring including at least one tooth extending from the tooth ring;
the resilient torque member comprises a spring ring rotatably fixed to the other of the one of the first face and the second face, the spring ring including at least one resilient finger extending toward the at least one tooth; and
rotation of the second nut in the first direction compresses the at least one resilient finger with the at least one tooth to rotate the first nut in the first direction until the at least one resilient finger is compressed out of engagement with the at least one tooth, and rotation in the second direction opposite to the first direction engages the at least one resilient finger with the at least one tooth to rotate the first nut in the second direction.

16. The torque-limiting bearing nut assembly of claim 15, wherein:
the tooth ring comprises a continuous band fixed to the first face; and
the spring ring comprises a cylindrical strip having tabs at both ends that extend through a slot in the second nut to rotatably fix the spring ring to the second nut.

17. A torque-limiting nut assembly engaging external threads of a shaft and imparting an axial force to a member engaged with the torque-limiting nut assembly, comprising:
a first nut having a first face and internal threads threadably engaging the external threads of the shaft;
a second nut having a second face facing the first face;
a resilient torque member between the first face and the second face, and rotatably fixed to one of the first nut and the second nut; and
a rigid torque member between the first face and the second face, and rotatably fixed to the other of the one of the first nut and second nut;
wherein rotation of the second nut in a first direction relative to the shaft compresses the resilient torque member with the rigid torque member and moves the first nut along the shaft in a first axial direction until the resilient torque member is compressed out of engagement with the rigid torque member; and
wherein rotation of the second nut in a second direction opposite to the first direction engages the resilient torque member with the rigid torque member to rotate the first nut in the second direction and moves the first nut along the shaft in a second axial direction opposite the first axial direction.

18. The torque-limiting nut assembly of claim 17, wherein the shaft is at least one of a bearing sleeve and a lug.

19. The torque-limiting nut assembly of claim 17, wherein the member is at least one of an adaptor sleeve and a hub.
